(19) United States
(12) Patent Application Publication
(10) Pub. No.: US 2026/0307745 A1
(43) Pub. Date: Oct. 8, 2026

(54) ADJUSTABLE AERODYNAMIC PANELS AND ASSEMBLIES AND METHODS OF MANUFACTURING, INTEGRATING, AND USING THE SAME

(71) Applicant: Daimler Truck North America LLC, Portland, OR (US)

(72) Inventors: Braden BEHAN, Portland, OR (US); Joshua HANCOCK, Portland, OR (US)

(21) Appl. No.: 19/483,124

(22) PCT Filed: May 10, 2024
(86) PCT No.: PCT/US2024/028833

§ 371 Date: Nov. 10, 2025

Related U.S. Application Data
(60) Provisional application No. 63/466,117, filed on May 12, 2023.

(51) Int. Cl. B62D 35/00

(52) U.S. Cl. CPC B62D 35/001; B62D 35/008

(57) ABSTRACT

Adjustable aerodynamic panels, assemblies with adjustable aerodynamic panels, and methods of manufacturing, integrating, and using the same. In embodiments, an aerodynamic assembly for a vehicle includes a frame, a panel, and a mounting bracket. The mounting bracket couples the panel to the frame, e.g., adjacent to one or more wheels of the vehicle. In embodiments, the mounting bracket includes a first member that couples to the panel and a second member that couples (directly or indirectly) to the frame, the first member and the second member movable relative to each other so that the panel can be adjusted between a first position, e.g., a retracted position, e.g., that is closer to the wheels and/or frame, and a second position, e.g., an extended position, that is further from the wheels and/or frame. The latter position can provide increased clearance.

### BACKGROUND OF THE INVENTION

To help improve performance and increase fuel efficiency, many vehicles include aerodynamic panels on their external surfaces. These panels can help direct airflow over, around, and/or under the vehicles during forward motion, and thus can help improve aerodynamic performance. However, at times, certain modifications to a vehicle may be made for performance purposes. For example, in ice and/or snow conditions, traction devices may be installed on wheels of a vehicle to help maintain traction in changing road conditions. These traction devices for practical purposes may need to be installed in proximity to certain aerodynamic structures of a vehicle. This can at times result in interference between the adjacent structures.

### FIELD OF THE INVENTION

The field relates to aerodynamic components for vehicles.

### SUMMARY OF THE INVENTION

This summary is intended to introduce a selection of concepts in a simplified form that are further described below in the detailed description section of this disclosure. This summary is not intended to identify key or essential features of the claimed subject matter, nor is it intended to be used as an aid in isolation to determine the scope of the claimed subject matter.

In brief, and at a high level, this disclosure describes, among other things, adjustable aerodynamic panels, adjustable assemblies that include aerodynamic panels and mounting brackets, and methods of manufacturing, integrating, and using the same, e.g., in connection with different types of vehicles. The panels and assemblies described herein can impart aerodynamic properties to a vehicle while also being adjustable into different positions and/or configurations to accommodate different operating circumstances.

In embodiments, an adjustable fairing assembly is provided. The adjustable fairing assembly includes an aerodynamic panel that can be adjusted from a first position (e.g., a retracted position/configuration) to a second position (e.g., an extended position/configuration). This adjustability allows the aerodynamic panel to be positioned for greater clearance from one or more adjacent structures of the vehicle, e.g., wheels or wheel assemblies. For example, this adjustability can be used to increase clearance for a tire-traction device installed on an adjacent wheel or wheel assembly, and/or to increase clearance from other structures installed, re-positioned, and/or used in connection with a vehicle. This adjustability can help reduce, limit, and/or inhibit interference between the aerodynamic panel and the adjacent structures in certain operating circumstances.

In embodiments, an adjustable fairing assembly is provided that includes an aerodynamic panel and a mounting bracket. The assembly allows the aerodynamic panel to be attached to a vehicle, e.g., to a longitudinally-extending frame thereof. In an embodiment, the mounting bracket attaches the panel to a lateral side of the longitudinally-extending frame. The mounting bracket can include a first member that couples to the panel and a second member that couples, directly or indirectly, to the longitudinally-extending frame. The first member and the second member can be connected through a movable coupling that allows the first member and the second member to shift relative to each other (e.g., adjust between a retracted position/configuration and an extended position/configuration). This adjustability helps accommodate different operating circumstances. For example, the first position can be used when a tire-traction device is not installed on an adjacent wheel or wheel assembly, e.g., such that a smaller clearance between the panel and the wheel is suitable, and the second position can be used when a tire-traction device is installed on an adjacent wheel or wheel assembly, e.g., such that a larger clearance between the panel and the wheel is suitable.

In embodiments, different types of mounting brackets can be used to attach an aerodynamic panel to a vehicle in movable fashion. The mounting brackets can include multiple components, e.g., including those that are fixed and/or movable relative to each other. In embodiments, a mounting bracket can include members that are slidable relative to each other, e.g., translatable along a linear axis. In embodiments, a mounting bracket can include members that are rotatable/pivotal relative to each other, e.g., being rotatable about at least one axis. In embodiments, a mounting bracket can include members that are both slidable and rotatable/pivotal relative to each other, e.g., allowing for multi-axis translation/rotation. These different types of adjustments can be provided through use of sliding and/or pivoting mechanical connections. In embodiments, a mounting bracket can also include one or more locking features operable to lock or fix the relative position of the movable members. Locking features without limitation can include fasteners, e.g., pins, including cotter pins, bolts, screws, rivets, and the like, as well as clips, hook-and-loop attachments, frictionally-based attachments (e.g., that can be adjusted to increase or decrease frictional engagement between adjacent structures), male-female attachments (e.g., structures that are insertable and removable relative to each other), or other mechanical locking features, assemblies, or mechanisms in accordance with different embodiments herein. In embodiments, a movable coupling that allows the members of a mounting bracket to adjust can also be configured for reversibly locking/fixing the members of the mounting bracket in different relative positions. For example, a movable coupling that includes a pin, a slot, and stop-surfaces located at opposite ends of the slot can be used for reversibly locking/fixing components in different positions without requiring the structures to be de-coupled or disassembled, e.g., using tools.

In embodiments, a mounting bracket is configured such that one of first and second members of the mounting bracket has a slot and the other of the first and second members of the mounting bracket has a pin that engages with and slides along the slot, thereby allowing for movement of the first and second members relative to each other. In embodiments, the slot includes a curved and/or arcuate portion that can support the pin, thereby allowing an attached panel to be held in a fixed position without additional locking structures or manual support. In embodiments, a biasing member, e.g., a coil spring or a leaf spring, may be used to bias the mounting bracket and by association the panel towards a particular position (e.g., a retracted position). In such embodiments, the biasing member can be used to help hold, support, or retain the panel in desired positions.

The embodiments herein can help limit, reduce, and/or inhibit interference between panels and adjacent vehicle structures under different operating circumstances. These embodiments can also help reduce noise and degradation of components, and thus can help increase the operational life of components. These embodiments can also help increase the efficiency, speed, and ease of re-configuring a vehicle aerodynamic assembly for different operating circumstances, among other benefits.

### BRIEF DESCRIPTION OF THE DRAWING

The aerodynamic panels, assemblies with the same, and methods of manufacturing, integrating, and using the same described herein are discussed in detail in connection with the attached drawing figures, which illustrate non-limiting examples of the described subject matter, in which:

FIG. 1 depicts a side-plan view of a vehicle with a movable aerodynamic assembly, in accordance with an embodiment of the present disclosure;

FIG. 2 depicts a perspective view of a mid-panel movable aerodynamic assembly, in accordance with an embodiment of the present disclosure;

FIG. 3 depicts a side-plan view of the mid-panel movable aerodynamic assembly of FIG. 2 with the assembly in a retracted position, in accordance with an embodiment of the present disclosure;

FIG. 4 depicts an enlarged side-plan view similar to FIG. 3 with parts broken away to reveal details of the movable aerodynamic assembly, in accordance with an embodiment of the present disclosure;

FIG. 5 depicts a side-plan view of the mid-panel movable aerodynamic assembly of FIG. 2 with the panel in transition from the retracted position to the extended position, in accordance with an embodiment of the present disclosure;

FIG. 6 depicts an enlarged side-plan view similar to FIG. 5 with parts broken away to reveal details of the movable aerodynamic assembly, in accordance with an embodiment of the present disclosure;

FIG. 7 depicts a side-plan view of the mid-panel movable aerodynamic assembly of FIG. 2 with the panel in its extended position, in accordance with an embodiment of the present disclosure;

FIG. 8 depicts an enlarged plan view similar to FIG. 7 with parts broken away to reveal details of the movable aerodynamic assembly, in accordance with an embodiment of the present disclosure;

FIG. 9 depicts a top perspective view of a member of a mounting bracket that attaches to a frame and that has positioning slots provided therein, in accordance with an embodiment of the present disclosure;

FIG. 10 depicts a perspective view of an aft-panel movable aerodynamic assembly, in accordance with an embodiment of the present disclosure;

FIG. 11 depicts a side-plan view of the aft-panel movable aerodynamic assembly of FIG. 10, with the assembly in a retracted position, in accordance with an embodiment of the present disclosure;

FIG. 12 depicts an enlarged side-plan view similar to FIG. 11 with parts broken away to reveal details of the movable aerodynamic assembly, in accordance with an embodiment hereof;

FIG. 13 depicts a side-plan view of the aft-panel aerodynamic assembly of FIG. 10 with the panel in transition from the retracted position to the extended position, in accordance with an embodiment of the present disclosure;

FIG. 14 depicts an enlarged side-plan view similar to FIG. 13 with parts broken away to reveal details of the movable aerodynamic assembly, in accordance with an embodiment of the present disclosure;

FIG. 15 depicts a side-plan view of the aft-panel aerodynamic assembly of FIG. 10 with the panel in its extended position, in accordance with an embodiment of the present disclosure;

FIG. 16 depicts an enlarged plan view similar to FIG. 15 with parts broken away to reveal details of the assembly, in accordance with an embodiment of the present disclosure;

FIG. 17 depicts a top perspective view of a member of a mounting bracket that is attached to an aft panel and that has positioning slots provided therein, in accordance with an embodiment of the present disclosure;

FIG. 18 depicts a tire with a traction device attached thereto, in accordance with an embodiment of the present disclosure;

FIG. 19 depicts a block diagram of a method of manufacturing a movable aerodynamic panel, in accordance with an embodiment of the present disclosure; and

FIG. 20 depicts a block diagram of a method of integrating a movable aerodynamic panel into a vehicle, in accordance with an embodiment of the present disclosure.

### DETAILED DESCRIPTION OF THE INVENTION

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar to those described in this disclosure, and in conjunction with other present or future technologies or solutions. Moreover, although the terms “step” or “block” may be used herein to identify different elements of methods employed, the terms should not be interpreted as implying any particular order among or between different elements except when the order is explicitly stated.

In general, and at a high level, provided herein are adjustable aerodynamic panels, adjustable assemblies including fairing assemblies with adjustable aerodynamic panels, and methods of manufacturing, integrating, and using the same, among other things. The aerodynamic panels and assemblies described herein can be used to impart aerodynamic properties to a vehicle while also being adjustable into different positions and/or configurations, thereby increasing the adaptability and benefit of such components. The ability to adjust, re-position, and/or re-configure an aerodynamic panel using the assemblies described herein can help reduce interference between components, reduce noise, wear, and degradation of structures, and reduce the complexity of modifying a vehicle assembly for particular purposes, among other benefits.

Due to ongoing fluctuations in fuel prices, changing supply and demand for fuel, and changing environmental regulations, there is an increasing focus on fuel efficiency in vehicles, and especially vehicles associated with transport of heavy cargo, such as freight trucks. To help increase fuel efficiency and performance, aerodynamic structures are often integrated into vehicles. For example, in the instance of freight trucks, aerodynamic features such as hoods, cones, fins, slanted surfaces, panels, fairings, and the like can be introduced to facilitate increased aerodynamic performance. These structures help reduce turbulent airflow and/or airflow encountering a significant change in direction, both of which can reduce aerodynamic performance and thus decrease fuel efficiency.

Notably, one part of a freight truck that can impact aerodynamic performance (e.g., reduce aerodynamic efficiency) is wheels and wheel assemblies, e.g., due to the gaps, openings, and non-contoured geometries often associated with these components and assemblies. To improve aerodynamic performance in these areas, panels and/or fairings can be positioned in gaps located between wheels or wheel assemblies and/or adjacent to outer wheels or wheel assemblies to produce a more linear contour across these portions of the freight vehicle. These more linear contours help facilitate more laminar airflow, rather than turbulent airflow, in these areas. For example, a mid-panel or fairing can be positioned between two wheels (e.g., located on adjacent axles) forming a tandem wheel assembly, and/or an aft-panel or fairing can be positioned adjacent to a trailing wheel (e.g., located on a rear axle) to help provide a more linear contour or profile in these areas that facilitates more laminar airflow and thus increased aerodynamic efficiency in these areas.

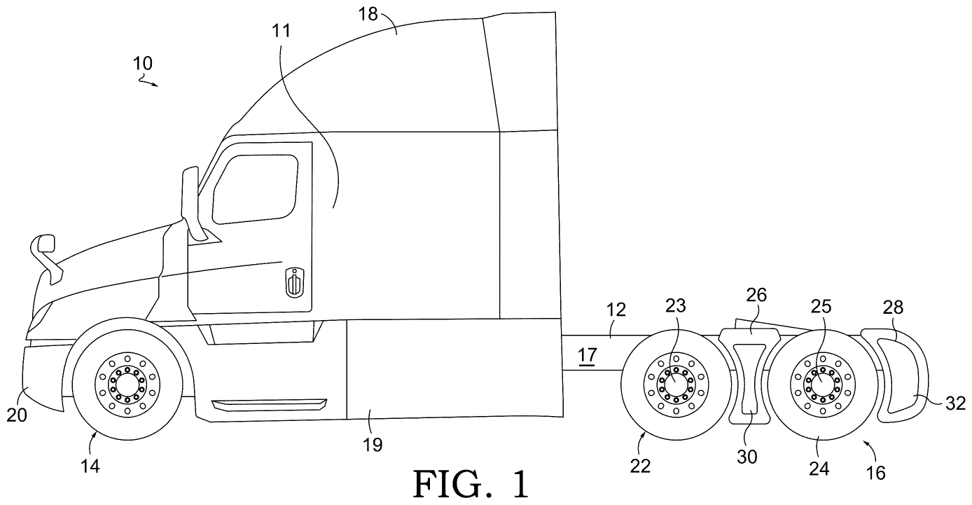

In addition to increasing aerodynamic performance, freight transport often must be able to continue in all sorts of conditions, e.g., ice, snow, and other inclement weather. When traveling in these conditions, it can be helpful to install traction devices on the wheels of a freight truck. These traction devices can be chains, wires, or cables (e.g., that secure around a tire) or other forms of tire-wraps or tire-coverings that enhance traction between the tire and a road surface. These traction devices are installed externally on the tire, and thus extend outward some distance from the tire on which they are installed. Thus, when such traction devices are used, they can create interference with structures that otherwise normally have clearance from the tire, e.g., such as panels or fairings installed adjacent to a wheel or wheel assembly that are intended to improve aerodynamic performance in these areas. In addition, during forward motion of a freight vehicle, a traction device that is installed on a wheel can impact the adjacent panels or fairings due to rotation of the traction device that may even further increase its rotational profile. Thus, it is desirable to reposition or displace the panels/fairings laterally to increase the clearance between the traction device and the panels, and in addition, it is desirable to be able to displace the panels/fairings with limited additional hardware, e.g., pins, bolts or other securing structures, to thereby reduce the complexity, equipment, and time required to complete such adjustments. FIGS. 1-20 described further below illustrate non-limiting embodiments that can provide such benefits, among others.

Looking now at FIG. 1, a vehicle 10 is shown, in accordance with an embodiment of the present disclosure. In FIG. 1, the vehicle 10 is a freight truck that includes multiple axles and multiple wheel assemblies. However, it should be noted that many other types of vehicles are contemplated in connection with the embodiments described herein.

The vehicle 10 includes a cab 11, a frame 12, a front wheel assembly 14 attached to the frame 12, and a rear wheel assembly 16 attached to the frame 12. The cab 11 also includes a hood 18, a cab fairing 19, and a bumper 20 each having, at least in part, an aerodynamic surface. The frame 12 is longitudinally-extending, or rather extends in a lengthwise direction that is defined as the direction extending between the front wheel assembly 14 shown in FIG. 1 and the rear wheel assembly 16 shown in FIG. 1. FIG. 1 thus looks along a lateral direction that is substantially perpendicular to the lengthwise, or longitudinally-extending, direction (the latter also being associated with the direction of a traditional drive-shaft). The frame 12 includes at least two longitudinally-extending rails (one rail 17 being shown in FIG. 1). These rails can extend substantially in parallel along the lengthwise direction of the vehicle 10 and form part of a chassis thereof.

FIG. 1 shows the rear wheel assembly 16. The rear wheel assembly 16 includes a pair of adjacent wheels 22, 24. The wheels 22, 24 are mounted on a pair of adjacent axles 23, 25 attached to the frame 12. While not shown in FIG. 1, each wheel 22, 24 may actually be one of multiple wheels installed on a common axle 23, 25. The wheel 22 is positioned forward of the wheel 24 (e.g., along the lengthwise direction of the frame 12 as referenced above). The rear wheel assembly 16 includes an adjustable aerodynamic panel/fairing 26 (referred to herein as “panel 26”) and an adjustable aerodynamic panel/fairing 28 (referred to herein as “panel 28”) that each have an aerodynamic surface that is outward-facing and used to direct airflow. In embodiments, aerodynamic surfaces, as referred to herein, can be flat or substantially flat, curved or substantially curved, and/or contoured or substantially contoured at least along a direction that airflow travels across the surface during operational use. In embodiments, an aerodynamic surface can have a partially convex shape or convex shape. In embodiments, an aerodynamic surface can be a partially smooth surface or smooth surface. The aforementioned aerodynamic surfaces can be shaped to reduce aerodynamic drag and help generate more laminar airflow across the surface as opposed to more turbulent airflow across the surface (as determined by the Reynolds number of the flow) during use.

Looking at FIG. 1, the panel 26 is positioned between the wheel 22 and the wheel 24. In this position, during forward motion of the vehicle 10, the panel 26 helps direct airflow linearly across the wheels 22, 24 instead of inward between the wheels 22, 24 where the airflow can become more turbulent, and therefore increase aerodynamic drag, and reduce aerodynamic performance. While not shown in FIG. 1, it should be noted that a similar configuration of aerodynamic panels and adjacent wheels may be present on the opposite lateral side of the vehicle 10 (i.e., on the opposite side of the frame 12).

The panel 26 has an aerodynamic surface 30. The surface 30 is shaped to help direct airflow across the wheels 22, 24. The panel 28 is positioned adjacent to a trailing edge of the wheel 24. The panel 28 has an aerodynamic surface 32. The surface 32 helps direct airflow across the panel 28 and also helps direct airflow more linearly behind the vehicle 10. In this sense, the panel 28 can help reduce the airflow that might otherwise be diverted, e.g., due to pressure differentials and/or cross-flows, under a trailer pulled behind the vehicle 10. This type of airflow diversion can have a turbulent quality that increases aerodynamic drag and thus reduces aerodynamic efficiency, and thus, inhibiting it through use of the panel 28 can help increase the overall aerodynamic efficiency of the vehicle 10.

During operation of the vehicle 10 in snow or ice conditions, a traction device, e.g., the tire-traction device 35 shown in FIG. 18, can be installed on the wheels 22, 24 of the vehicle 10 to help increase traction with a road surface. Traction devices as discussed herein can include tire-chains, tire-wires, tire-cables, tire-wraps, or other components that partially or fully circumscribe a wheel to help increase traction between a tire surface and a road surface. In addition, because of the proximity of the wheels 22, 24 to the panels 26, 28, traction devices installed on the wheels 22, 24 that increase their circumferential profile can potentially interfere with the panels 26, 28 when the vehicle 10 is in motion. This interference can include brushing, scraping, impacting, and/or even dislodging the panels 26, 28. Thus, the ability to shift the panels 26, 28 outward from the frame 12 in the lateral direction to increase clearance between the panels 26, 28 and the wheels 22, 24 can help reduce noise, reduce wear, and/or reduce degradation of components, among other benefits. In addition, assemblies that can do so with limited additional hardware, equipment, or tools are especially beneficial due to the reduced complexity, cost, and time required for adjusting such assemblies, e.g., when the vehicle 10 is in use and/or in transit.

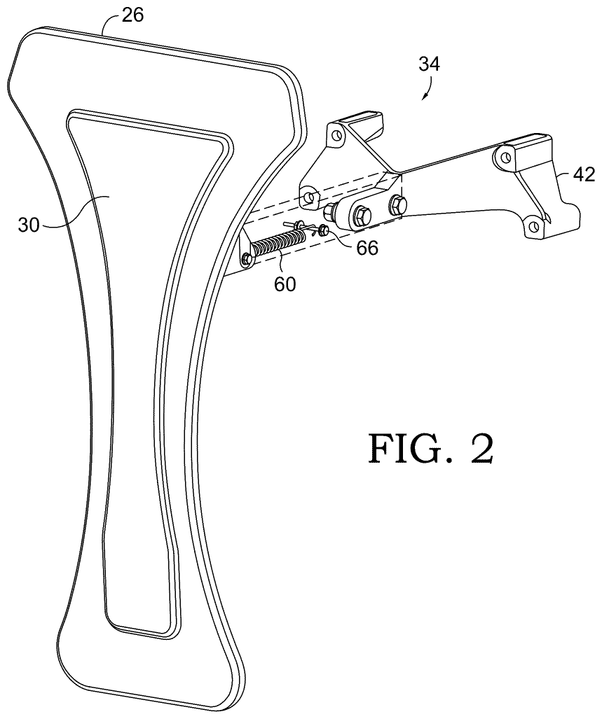

Looking now at FIGS. 2-9, an assembly that allows the panel 26 shown in FIG. 1 to be adjusted into different positions, e.g., extended and retracted positions, is shown, in accordance with an embodiment of the present disclosure.

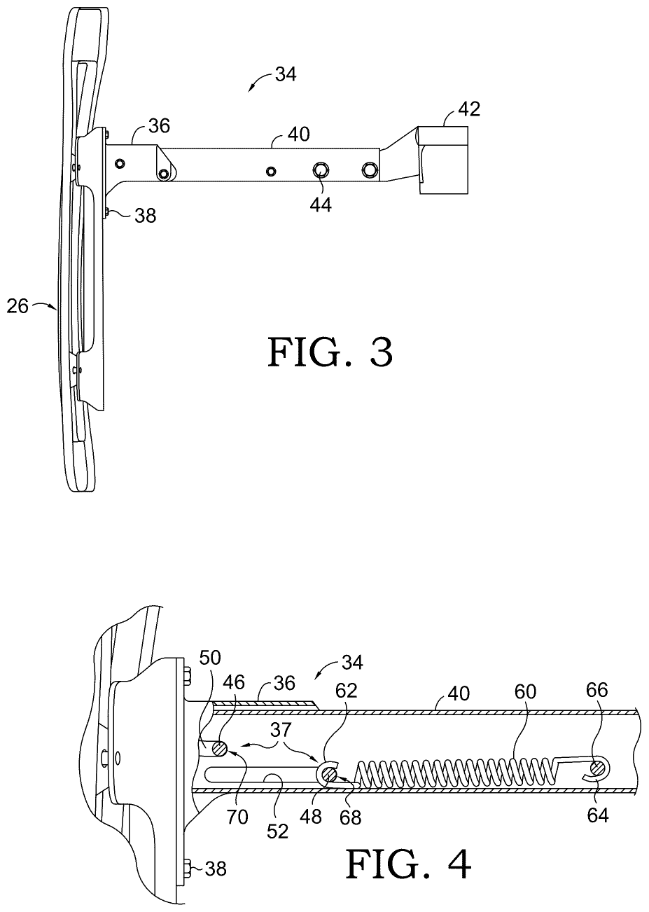

It can be seen in FIG. 2 that the panel 26 is attached to a mounting bracket 34. In different embodiments, the mounting brackets described herein can be formed from multiple components that are assembled together such that the components are substantially fixed relative to each other (e.g., with fasteners, e.g., like the example fastener 44 shown in FIG. 3), and/or that are adjustable relative to each other, e.g., such that the components are movable into different positions relative to each other in a particular range of motion as shown for example in FIGS. 2-9.

The mounting bracket 34 shown in FIGS. 2-9 includes a member 36 that couples to the panel 26, e.g., in this instance using fasteners 38, and a member 40 that couples to the frame 12 shown in FIG. 1. The member 40 couples to the frame 12 through a connection mount 42. In embodiments, the member 40 and/or connection mount 42 may couple to the frame 12 directly, or indirectly, e.g., through additional interposed components and/or structures. The connection mount 42 can be attached to the frame 12 in different ways, e.g., using fasteners (e.g., bolts, screws, rivets, or other types of fasteners), welding, interlocking structures, and/or using other types of mechanical attachments.

The mounting bracket 34 includes a movable coupling 37 that connects the member 36 and the member 40. In particular, the movable coupling 37 allows the members 36, 40 to shift into different positions relative to each other. In the depicted embodiment, the movable coupling 37 is configured so that the member 36 and the member 40 can both slide and pivot/rotate relative to each other.

To form the movable coupling 37, the member 36 includes a pin 46 coupled thereto and a pin 48 coupled thereto, and the member 40 includes a slot 50 formed therein and a slot 52 formed therein. The pin 46 is positioned in the slot 50. The pin 46 is slidable along the slot 50 and is also rotatable within the slot 50. The pin 48 is positioned in the slot 52. The pin 48 is slidable along the slot 52 and is also rotatable within the slot 52. The slot 50 has a linear portion 54, a curved and/or arcuate portion 56, and a stop-surface 58 located at an end of the curved and/or arcuate portion 56. This configuration allows the pin 46 to travel along a non-linear path in the slot 50. The curved and/or arcuate portion 56 is shaped such that it turns at least partially back towards the linear portion 54 (this allows the pin 46 to be shifted against the stop-surface 58 as explained below). The slot 52 is substantially linear in shape. This configuration allows the pin 48 to slide along a length of the slot 52.

The ability of the pins 46, 48 to move along their corresponding slots 50, 52 allows the members 36, 40 to change position relative to each other, and also allows the panel 26 to be shifted linearly and rotationally between a retracted position/configuration and an extended position/configuration. This configuration also allows the components to be shifted while the members 36, 40 remain movably connected. To state it differently, the configuration of the pins 46, 48 and the slots 50, 52 allows the panel 26 to be shifted without de-coupling, disassembling, and/or detaching the members 36, 40 from each other, e.g., through tool-based manipulation. In other words, the components can be shifted without requiring that tools be used to unfasten or unfix the members 36, 40 from each other in order to render them movable. The adjustment can thus be completed in a tool-less fashion. This helps reduce the time, complexity, and tooling required to complete an adjustment of the panel 26 and can be especially beneficial in circumstances where tools and the components themselves are not easily accessible, e.g. at a roadside.

Looking at FIGS. 2, 4, and 6, a biasing member 60 is shown. The biasing member 60 can be integrated with the mounting bracket 34 to bias the panel 26 in a particular direction, e.g., towards the connection mount 42 and by association toward frame 12 of the vehicle 10 in accordance the configuration shown in FIG. 1. In other words, the biasing member 60 can bias the panel 26 toward the retracted position, e.g., the position closer to the frame 12, e.g., associated with no tire-traction device being installed on an adjacent wheel. In different embodiments, the biasing member 60 can be a spring, e.g., a leaf spring or a coil spring as shown in FIGS. 2, 4, and 6, and can also be a flexible elastic element, a piston, or another type of biasing structure. FIGS. 2, 4, and 6 depict how an end 62 of the biasing member 60 is coupled to the pin 48 of the member 36, and how an end 64 of the biasing member 60 is coupled to a structure 66 (e.g., in this instance being a bolt assembly that extends through the member 40) on the member 40. The biasing member 60 helps hold the panel 26 in its retracted position and also helps lock the panel in its extended position, e.g., in the outward, deployed configuration, as discussed below. The biasing member 60 can be configured such that it remains under substantially constant tension in each of these positions, or, stated differently, the biasing member 60 can be configured such that it imparts a biasing force in each of these positions. For example, the biasing member 60 can be under a certain amount of tension when the panel 26 is in its retracted position, e.g., as shown in FIG. 3, and can be under a different amount of tension (e.g., a greater amount of tension) when the panel 26 is in its extended position, e.g., as shown in FIG. 8.

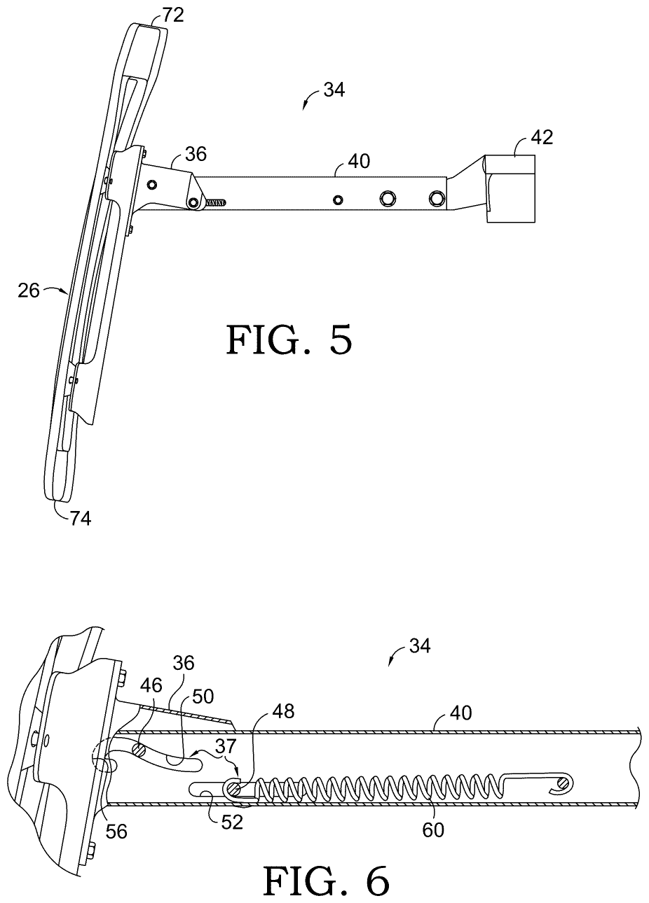

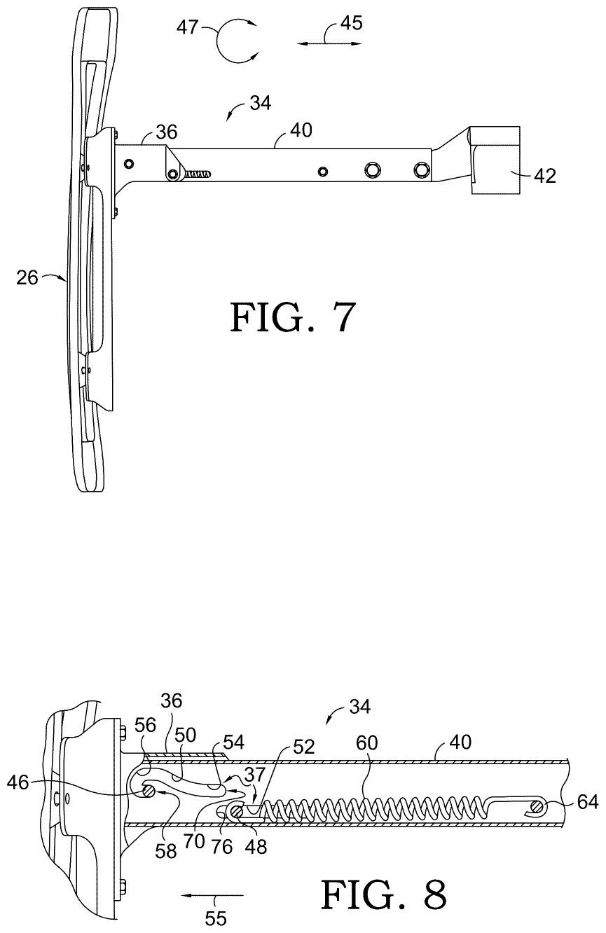

The shifting of the panel 26 and the movement thereof between the retracted position (e.g., the operating position that is associated with no tire-traction device being installed on an adjacent wheel) and the extended position (e.g., the operating position that is associated with a tire-traction device being installed on an adjacent wheel) will be described with reference to FIGS. 2-9. FIGS. 2-4 depict the panel 26 in the retracted position. FIGS. 5 and 6 depict the panel 26 in the intermediate extended position, or rather, on its way to the extended position that provides increased clearance between the panel 26, or a portion thereof, and an adjacent vehicle wheel, e.g., wheel 22 and/or wheel 24 as shown in FIG. 1. FIGS. 5 and 6 show how the panel 26 is operated, e.g., being pivoted and pulled outward from the frame 12 to allow it to shift from the retracted position to the extended position. FIGS. 7 and 8 depict the panel 26 in its extended and reversibly locked or fixed position that is provided by the pin 46 being seated on the stop-surface 58 of the slot 50.

Looking first at FIGS. 2-4, the panel 26 is shown in its retracted position that corresponds to the wheels 22, 24 of the vehicle 10 shown in FIG. 1 not having tire-traction devices installed thereon (or that corresponds to another structural configuration suitable for a smaller degree of clearance). In this configuration, the pin 48 attached to the member 36 abuts against a stop-surface 68 located at an end of the slot 52, as shown in FIG. 4. The pin 48 is biased into this position by the biasing member 60. The biasing member 60 can be configured to remain under some tension in this position to help hold the panel 26 in this retracted position. In addition, in this configuration, the pin 46 attached to the member 36 abuts against a stop-surface 70 located at an end of the slot 50, as shown in FIG. 4.

Looking at FIGS. 5 and 6, the transition from the retracted position of the panel 26 shown in FIGS. 2-4 to the extended position shown in FIG. 8 is depicted. In order to transition the panel 26 to its extended position, the panel 26 can be manually engaged at an edge 72 (e.g., a top edge) thereof and/or at an edge 74 (e.g., a bottom edge) thereof. The panel 26 can then be pivoted such that the top edge 72 shifts towards the connection mount 42 and by association towards the frame 12, shown in FIG. 1, and the bottom edge 74 shifts away from the connection mount 42 and by association away from the frame 12, shown in FIG. 1. To state it differently, the movable coupling 37 allows the panel 26 to be rotatably adjusted into an angled position relative to the frame 12 such that the top edge 72 is closer to the frame 12 than the bottom edge 74. The panel 26 can then be shifted outward, e.g., away from, the connection mount 42 and by association the frame 12 shown in FIG. 1. This shifting results in extension of the biasing member 60 as shown in FIG. 6. Further, the pin 48 in the slot 52 moves from the stop-surface 68 as shown in FIG. 4 which results in extension of the biasing member 60. The pin 46 also moves within the slot 50 toward the curved and/or arcuate portion 56. The pin 48 traveling in the slot 52 and the pin 46 traveling in the slot 50 results in a rotating and sliding motion of member 36 relative to the member 40.

Looking now at FIGS. 7 and 8, the panel 26 is shown in its extended position, e.g., the deployed position that can provide additional clearance from a wheel with a tire-traction device installed thereon (or additional clearance from another vehicle structure). In the context of FIG. 1, the position of the panel 26 shown in FIGS. 7 and 8 results in the panel 26 being displaced laterally-outward from the frame 12 shown in FIG. 1, e.g., in a direction substantially perpendicular to the lengthwise direction of the frame 12 identified in connection with FIG. 1. This extended position allows a traction device to be installed around either or both of the wheels 22, 24 and/or allows the traction device to operate (e.g., rotate with the wheel) with reduced interference between the traction device and the panel 26. In addition, in this extended position, the pin 46 has moved through the curved and/or arcuate portion 56 of the slot 50 and is abutted against the stop-surface 58 of the slot 50. This position of the pin 46 results in the panel 26 being reversibly secured or fixed in the extended position. The pin 48 is also shifted within the slot 52 to a position towards the outward end 76 of the slot 52. FIG. 7 also depicts the biasing member 60 in an extended position, or rather, being extended further compared to the retracted position of the panel 26 as shown in FIG. 4. The force imparted by the biasing member 60 helps bias the pin 46 against the stop-surface 58 thus helping to hold or fix the panel 26 in its extended position.

Looking at FIG. 8, it can be seen that the stop-surfaces 58, 70 located at opposite ends of the slot 50 are oriented to face generally in a same direction (e.g., direction 55 identified in FIG. 8). To state it differently, the stop-surfaces 58, 70 are oriented so that a concave portion of each stop-surface 58, 70 faces generally in the same direction (e.g., direction 55 identified in FIG. 8). This orientation of the stop-surfaces 58, 70 on the slot 50 allows the biasing member 60 to bias the pin 46 against either the stop-surface 58 (if the pin 46 is shifted to one end of the slot 50 as shown in FIG. 8) or bias the pin 46 against the stop-surface 70 (if the pin 46 is shifted to the other end of the slot 50 as shown in FIG. 4). Having the stop-surfaces 58, 70 aligned in this fashion means that the panel 26 can be reversibly held, fixed, or locked in different positions based on the pin 46 being biased into contact with either the stop-surface 58 or the stop-surface 70. It also allows the panel 26 to be re-positioned by simply shifting the components against the force of the biasing member 60 to translate the pin 46 to the other end of the slot 50.

The configuration of the mounting bracket 34 and the movable coupling 37 allows for a substantially self-contained mechanical adjustment of the panel 26. In other words, shifting and reversibly locking the panel 26 into the extended position can be performed with reduced or substantially no need for additional locking pins, bolts, or devices using the depicted configuration of the mounting bracket 34. This can increase the efficiency and speed of adjusting the panel 26 into different positions, and reduce the incidence of inoperability due to missing parts required for securing the panel 26 in a particular position, among other benefits.

In order to shift the panel 26 from the extended position back to the retracted position, the process described above can be reversed. For example, the panel 26 can again be engaged at its edges 72 and/or 74, rotated, and pulled slightly outward to unseat the pin 46 from the stop-surface 58. The pin 46 can then be translated back through the curved and/or arcuate portion 56 of the slot 50, and the biasing member 60 exerts a force on the pin 48 that pulls the panel 26 towards the frame 12 and back to its retracted position, e.g., as shown in FIGS. 3 and 4. The panel 26 generally reaches its retracted position when the pin 46 reaches the other end of the slot 50 opposite to the stop-surface 58.

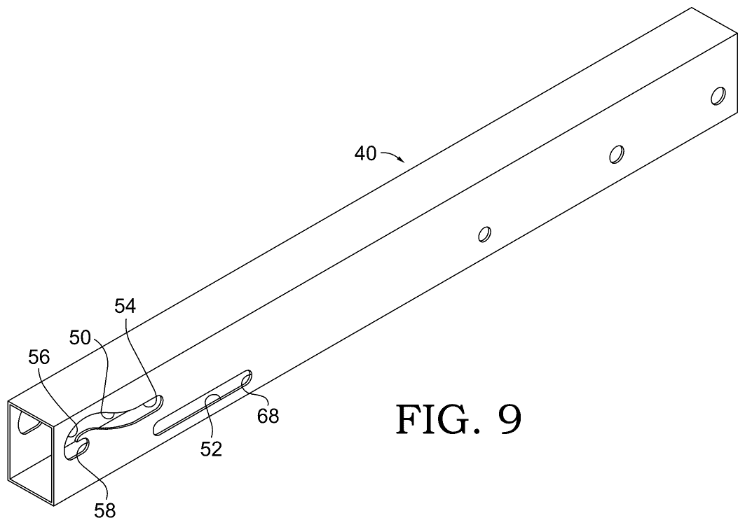

FIG. 9 shows the member 40 in isolation depicting the configuration of the slot 50 and the slot 52 in which the corresponding pins 46, 48 of the member 36 can slide to different positions to allow for adjustment of the member 36 relative to the member 40 to thereby allow for adjustment of the panel 26 into different positions.

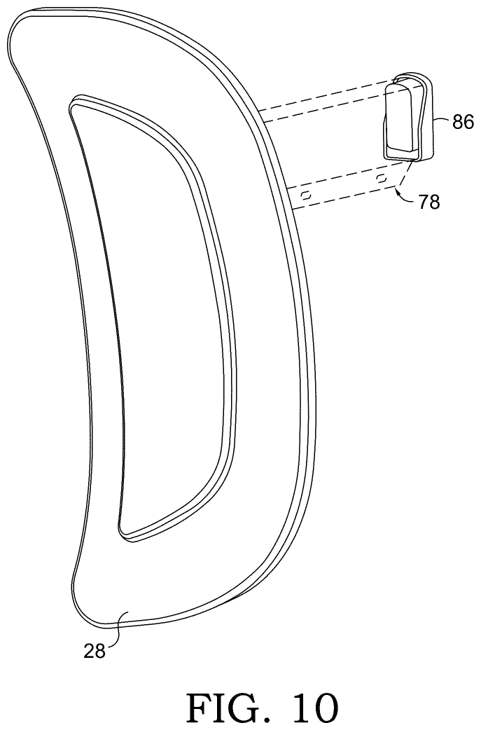

Looking now at FIGS. 10-17, the panel 28 of FIG. 1 is shown, and a mounting bracket 78 that attaches the panel 28 to the frame 12 in FIG. 1 is also shown, in accordance with an embodiment of the present disclosure. The mounting bracket 78 includes a member 80 attached to the panel 28, e.g., in this instance using fasteners 82, and a member 84 that attaches to the frame 12 through a connection mount 86. In embodiments, the member 84 and/or connection mount 86 may couple to the frame 12 directly, or indirectly, e.g., through additional interposed components and/or structures. The connection mount 86 can be attached to the frame 12 in different ways, e.g., using fasteners (e.g., bolts, screws, rivets, or other types of fasteners), welding, interlocking structures, and/or using other types of mechanical attachments.

Looking at FIGS. 12, 14, and 16, the mounting bracket 78 includes a movable coupling 75 that connects the member 80 and the member 84. The movable coupling 75 allows the members 80, 84 to shift into different positions relative to each other (similar to the movable coupling 37 described in connection with FIGS. 2-9). In the depicted embodiment, the movable coupling 75 is configured so that the member 80 and the member 84 are slidable and rotatable relative to each other. The mounting bracket 78 shown in FIGS. 10-17 is thus similar to the mounting bracket 34 described in connection with the panel 26 shown in FIGS. 2-9, except that the members 80, 84 generally corresponding to the members 36, 40 shown in FIGS. 2-9 have the slots and the pins reversed. More specifically, with the mounting bracket 78, the member 80 mounted to the panel 28 has the slots and the member 84 attached to connection mount 86 that couples to the frame 12 has the pins. In particular, there is a pin 88 and a pin 90 coupled to the member 84. The member 80 has a slot 92 formed therein and a slot 94 formed therein.

The pin 88 is slidably positioned in the slot 92 and the pin 90 is slidably positioned in the slot 94. The slot 92 has a substantially linear portion 96, a curved and/or arcuate portion 98, and a stop-surface 100 located at an end of the curved and/or arcuate portion 98. It can be seen from FIG. 12 that starting from the linear portion 96, the slot 92 initially inclines and then turns at least partially back towards the linear portion 96 proximate to the stop-surface 100 as shown in FIG. 12 (this shape enables reversibly fixing/locking the pin 88 at either end of the slot 92 as explained below). The movement of the pins 88, 90 along their corresponding slots 92, 94 allows the members 80, 84 to change position relative to each other, and also allows the panel 28 to be shifted linearly and rotationally between a retracted position/configuration and an extended position/configuration. This configuration also allows the components to be shifted while the members 80, 84 remain movably connected. To state it differently, the configuration of the pins 88, 90 and the slots 92, 94 allows the panel 28 to be shifted without de-coupling, disassembling, and/or detaching the members 80, 84 from each other, e.g., through tool-based manipulation. In other words, the components can be shifted without requiring that tools be used to unfasten or unfix the members 80, 84 from each other in order to render them movable. The adjustment can thus be completed in a tool-less fashion. This helps reduce the time, complexity, and tooling required to complete an adjustment of the panel 28 and can be especially beneficial in circumstances where tools and the components themselves are not easily accessible, e.g., at a roadside.

The slot 94 shown most clearly in FIG. 12 is generally linear in shape. The pin 90 is slidably received in the slot 94 such that it can slide therein. The pin 90 can also rotate within the slot 94 to allow rotation of the member 80 with respect to the member 84. The cooperation of the pin 88 with the slot 92 and the cooperation of the pin 90 with the slot 94 allows for the slidable and rotational movement of the member 80 with respect to the member 84 that also allows for adjusting the position of the panel 28 between the retracted position (e.g., associated with no tire-traction device being installed on an adjacent wheel where less clearance is suitable) and an extended position (e.g., associated with a tire-traction device being installed on an adjacent wheel where greater clearance is suitable to help limit or inhibit interference between the structures).

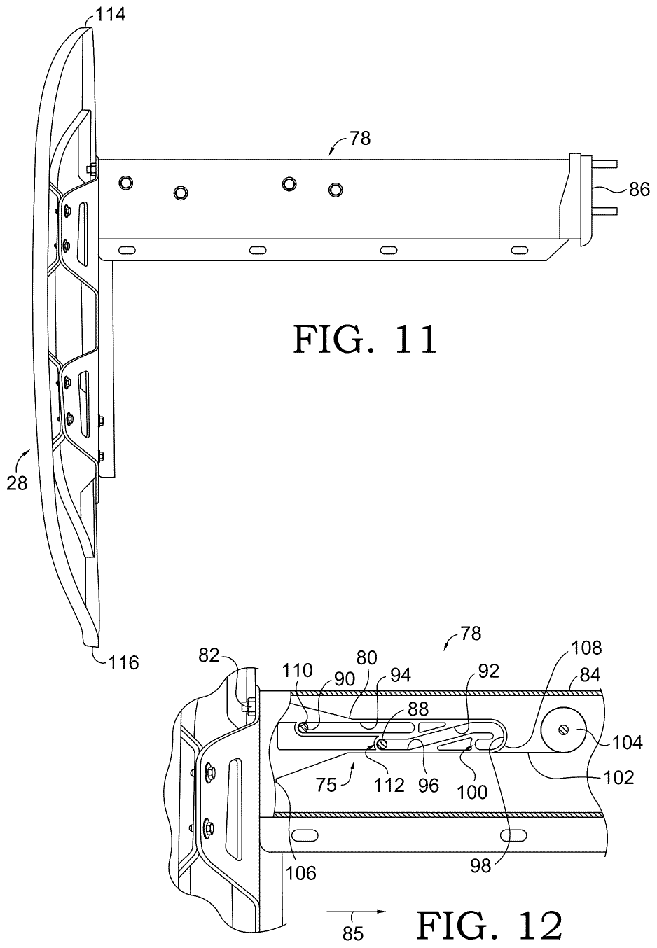

The mounting bracket 78 also includes a biasing member 102 integrated with the mounting bracket 78. The biasing member 102 helps bias the panel 28 towards the connection mount 86 and by association the frame 12 of the vehicle 10 shown in FIG. 1. In the depicted configuration, the panel 28 is biased towards the retracted position, e.g., closer to the connection mount 86, by the biasing member 102. The biasing member 102 can be any of the biasing members described herein, e.g., a spring, e.g., such as a leaf spring or a coil spring, or another biasing structure. The biasing member 102 is coupled to the member 84 at a location 104 and at a location 106. The biasing member 102 is deformable in the downward direction (e.g., relative to FIG. 14) and as it does so can exert an upward biasing force on an engaging surface 108 of the member 80 as shown in FIG. 14. The biasing member 102 helps retain the panel 28 in its retracted position and also helps reversibly lock or secure the panel in its extended position. In addition, the biasing member 102 may be positioned to continuously impart an upward biasing force on the surface 108 of the member 80. Specifically, the biasing member 102 may be under a certain amount of tension when the panel 28 is in its retracted position as shown in FIG. 11 and may be in a greater amount of tension when the panel 28 is in its extended position as shown in FIG. 16.

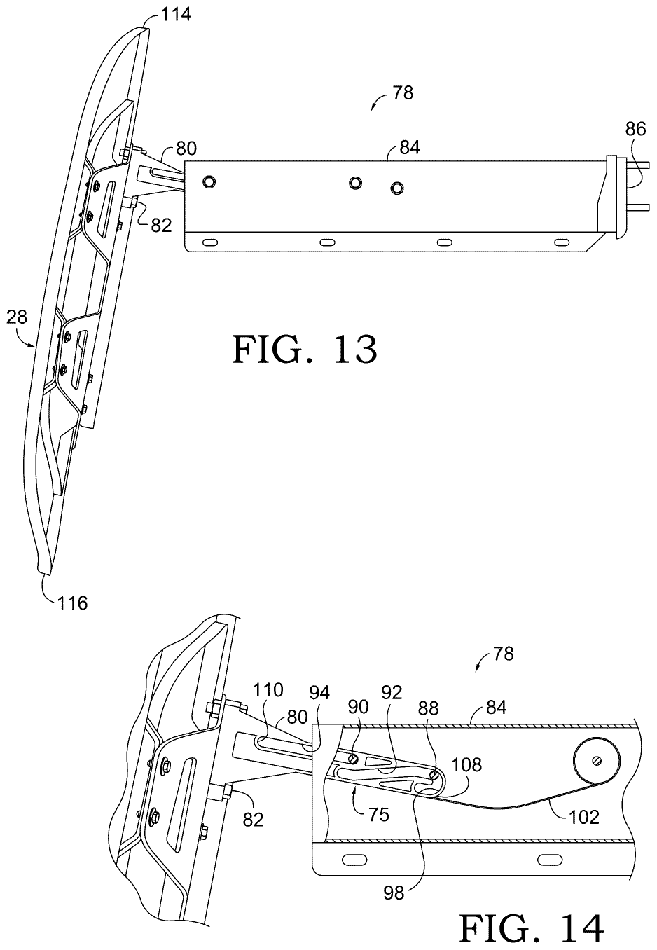

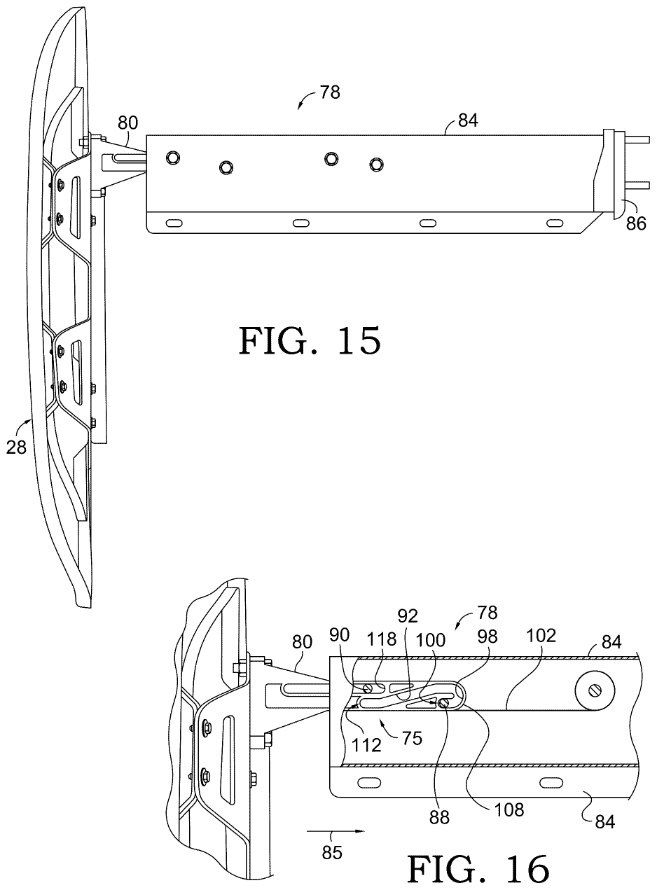

The operation of the panel 28 and the movement thereof between the retracted position (e.g., that may be used when no traction device is installed on an adjacent wheel) and the extended position (e.g., that may be used when a traction device is installed on an adjacent wheel) will be described with reference to FIGS. 10-17. FIGS. 10-12 depict the panel 28 in its retracted position. FIGS. 13 and 14 depict the panel during its deployment from the retracted position to the extended position. In particular, FIGS. 13 and 14 depict how the panel 28 can be pulled outward from the frame 12 of the vehicle 10 shown in FIG. 1 and rotated to facilitate lateral displacement. FIGS. 15 and 16 depict the panel 28 in its extended and reversibly locked or fixed position, such that the pin 88 is seated on the stop-surface 100 of the slot 92.

Looking at FIGS. 10-12, the panel 28 is shown in its retracted position that corresponds to the wheels 22, 24 not having a traction device positioned thereon. In this position, the pin 90 of the member 84 abuts against a stop-surface 110 in the slot 94 as shown in FIG. 12. The biasing member 102 helps hold the pin 90 in this position. In particular, the biasing member 102 exerts an upward force on the surface 108 of the member 80 to help hold the panel 28 in this retracted position as shown in FIG. 12. The pin 88 of the member 84 also abuts against a stop surface 112 in the slot 92 in the retracted position as shown in FIG. 12.

Looking at FIGS. 13 and 14, the transition of the panel 28 from the retracted position (e.g., the normal operating position) to the extended position (e.g., the deployed position) is shown, in accordance with an embodiment of the present disclosure. In order to transition the panel 28 to its extended position, the panel 28 can be engaged at an edge 114 (e.g., a top edge) and at an edge 116 (e.g., a bottom edge). The panel 28 can then be pivoted such that the edge 114 moves towards the connection mount 86 and by association the frame 12 of the vehicle 10 shown in FIG. 1 and the edge 116 moves away from the connection mount 86 and by association the frame 12 of the vehicle 10 shown in FIG. 1. The panel 28 can then be shifted outward away from the connection mount 86 and by association the frame 12 of the vehicle 10 shown in FIG. 1. This shifting results in further deflection of the biasing member 102 as shown in FIG. 14. In addition, the pin 90 in the slot 94 shifts from the stop-surface 110 which, through rotation of the panel 28, results in the deflection of the biasing member 102. The pin 88 also moves within the slot 92 towards engagement with the curved and/or arcuate portion 98. The translation of the pin 90 along the slot 94 and the translation of the pin 88 along the slot 92 results in a rotating and sliding motion of member 80 with respect to member 84 as shown in FIGS. 13 and 14.

Looking at FIGS. 15 and 16, the panel 28 is shown in the extended position, e.g., being extended outward from the connection mount 86 and by association the frame 12 of the vehicle 10 shown in FIG. 1, in accordance with an embodiment of the present disclosure. In the extended position, the panels 26, 28 may each be extended laterally (e.g., displaced along a direction substantially perpendicular to the lengthwise direction defined in connection with FIG. 1) from the frame 12. In different embodiments, the panels 26, 28 can be configured to displace laterally anywhere from 1-30 centimeters. In certain instances, at least a portion of the panels 26, 28 may extend outward laterally from the frame 12 a distance that is greater than a distance the wheels 22, 24 extend outward laterally from the frame 12. This relative positioning of the panels 26, 28 can facilitate clearance for a traction device installed on the wheel 22 and/or wheel 24. In one non-limiting embodiment, this differential can be anywhere from 1-20 centimeters. In the retracted position, the panels 26, 28 can extend outward laterally approximately an equal distance as the wheels 22, 24, a greater distance than the wheels 22, 24 (but less than the extended position), or a shorter distance than the wheels 22, 24 such that the wheels 22, 24 extend further outward laterally, in accordance with different embodiments.

In the extended position of the panel 28, e.g., as shown in FIGS. 15 and 16, the pin 88 has moved through the curved and/or arcuate portion 98 of the slot 92 and is abutted against the stop-surface 100 of the slot 92. This abutting results in the panel 28 being reversibly secured, fixed, or held in the extended position as shown in FIG. 16. In this instance, the pin 90 has also moved within the slot 94 to a position towards an end 118 of the slot 94. The biasing member 102 is also exerting an upward force on the surface 108 of the member 80 to help hold the panel 28 in the extended position. The force from the biasing member 102 helps hold the pin 88 against the stop-surface 100 thereby helping to reversibly secure, fix, or hold the panel 28 in its extended position.

Looking at FIGS. 12 and 16, the movable coupling 75 is configured so that the stop-surfaces 100, 112 on the slot 92 are oriented to face generally in the same direction (e.g., as indicated by arrow 85 in FIG. 16). This is similar to the configuration of the movable coupling 37 shown in FIGS. 4 and 8 but generally reversed in direction. This alignment of the stop-surfaces 100, 112 helps facilitate reversibly holding, fixing, or locking the pin 88 against the stop-surface 100 at one end of the slot 92 or against the stop-surface 112 at the other end of the slot 92, and thus by association, helps facilitate reversibly holding, fixing, or locking the panel 28 in different positions (e.g., extended or retracted) as described herein.

The configuration of the mounting bracket 78 allows for a substantially self-contained mechanical adjustment of the mounting bracket 78. In other words, shifting and reversibly locking the panel 28 into the extended position can be performed with reduced or substantially no need for additional locking pins, bolts, or devices using the depicted configuration. This can increase the efficiency and speed of adjusting the panel 28 into different positions, and reduce the incidence of inoperability due to missing parts required for securing the panel 26 in a particular position, among other benefits.

In order to shift the panel 28 from the extended position back to the retracted position, the process described above can be reversed. For example, the panel 28 can again be engaged at its edge 114 and/or edge 116, pivoted, and then pulled slightly outward to unseat the pin 88 from the stop-surface 100. The pin 88 can then be translated back through the curved and/or arcuate portion 98 of the slot 92, and eventually the biasing member 102 exerts a force on the surface 108 of the member 80 that helps pull the panel 26 towards the frame 12 and back to its retracted position, e.g., as shown in FIGS. 11 and 12. The panel 28 generally reaches its retracted position when the pin 88 reaches the other end of the slot 92 opposite to the stop-surface 100.

In some embodiments, a mounting bracket or mounting structure may shift or translate substantially linearly in order to displace a panel, e.g., laterally between a retracted position and an extended position as discussed herein. For example, a mounting bracket or structure can have a track-supported sliding structure and/or can have telescoping components that allow an attached panel to displace linearly, e.g., laterally relative to a frame. In addition, locking features can be used to support or fix the panel in certain displaced positions. For example, one or more bolts can be extended through alignable apertures in a track-supported or telescoping mounting bracket to help fix or hold the panel in a certain position.

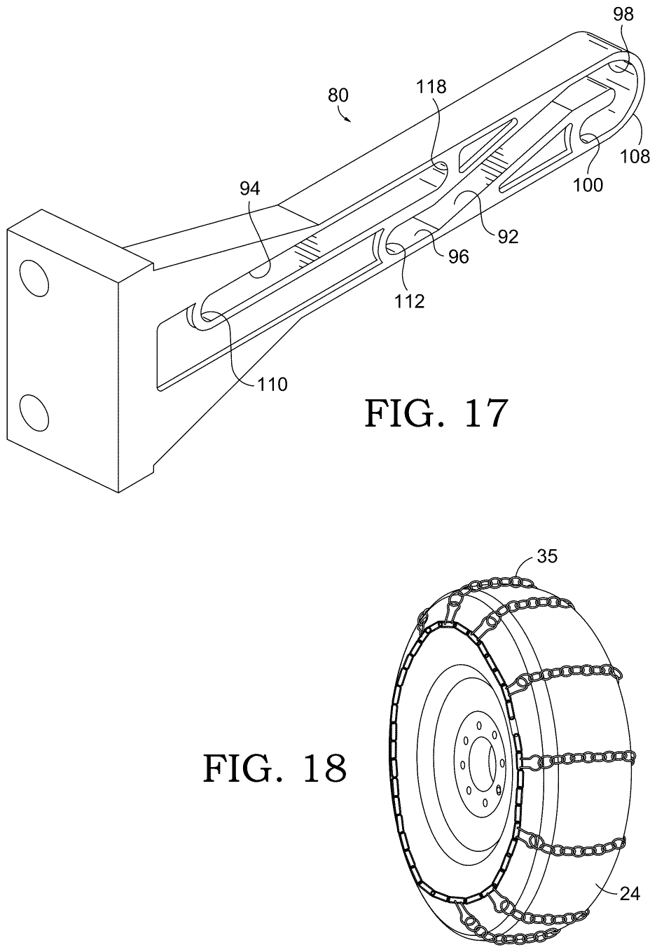

FIG. 17 shows the member 80 in isolation depicting the configuration of the slot 92 and the slot 94 in which the corresponding pins 88, 90 of the member 84 can slide to different positions to allow for adjustment of the member 80 relative to the member 84 to thereby allow for adjustment of the panel 28 into different positions.

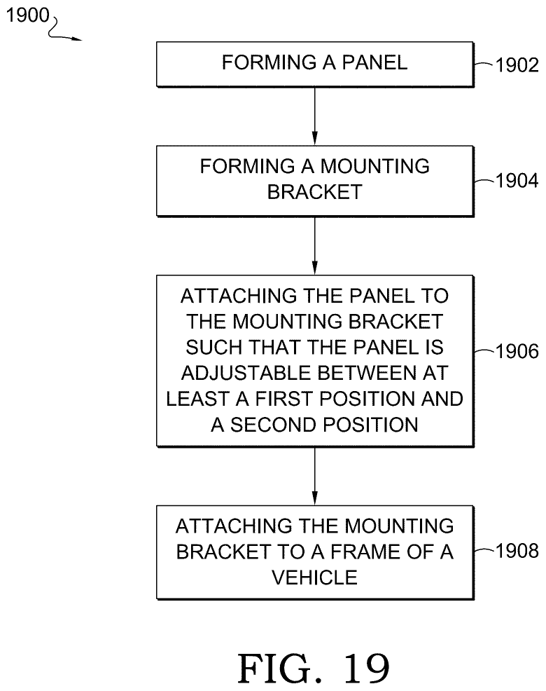

Looking at FIG. 19, a block diagram of a method 1900 of manufacturing an aerodynamic assembly for a vehicle is shown, in accordance with an embodiment of the present disclosure. The method 1900 includes blocks 1902-1908, but is not limited to this selection of elements. In block 1902, the method 1900 includes forming a panel, e.g., such as the panel 26 or 28 shown in FIG. 2. In block 1904, the method 1900 includes forming a mounting bracket, e.g., such as the bracket 34 shown in FIG. 2 or the mounting bracket 78 shown in FIG. 11. In block 1906, the method 1900 includes attaching the panel to the mounting bracket such that the panel is adjustable between at least a first position and a second position. In block 1908, the method 1900 includes attaching the mounting bracket to a frame of a vehicle, e.g., the frame 12 of the vehicle 10 shown in FIG. 1, adjacent one or more wheels, e.g., the wheels 22, 24 shown in FIG. 1, of the vehicle. The mounting bracket can attach the panel to the frame such that the panel is adjustable between a retracted position, closer to the frame, and an extended position, e.g., further from the frame to increase clearance for a traction device installed on one or more adjacent wheels of the vehicle, or to increase clearance for another structure or to provide additional room for access, cleaning, repair, maintenance, or other adjustment, modification, or reconfiguration.

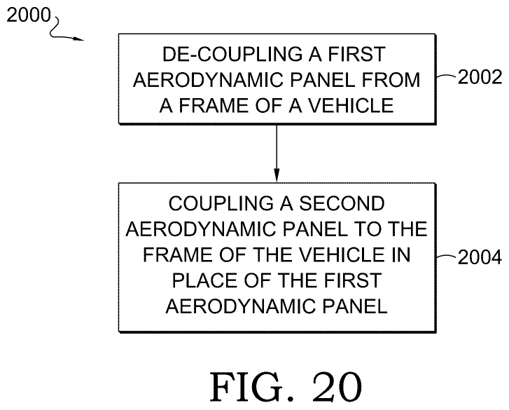

Looking now at FIG. 20, a method 2000 of integrating an adjustable aerodynamic panel into a vehicle, e.g., such as the vehicle 10 shown in FIG. 1, is shown, in accordance with an embodiment of the present disclosure. The method 2000 includes blocks 2002-2004, but is not limited to this selection of elements. In block 2002, the method 2000 includes de-coupling a first aerodynamic panel from a frame of a vehicle, e.g., such as the frame 12 of the vehicle 10 shown in FIG. 1. In block 2004, the method 2000 includes coupling a second aerodynamic panel, e.g., such as the panel 26 or 28 shown in FIG. 1, to the frame of the vehicle in place of the first aerodynamic panel, e.g., using a mounting bracket. For example, the panel can be coupled to the frame with a mounting bracket, e.g., such as the mounting bracket 34 or 78 shown in FIGS. 2 and 11, to allow the panel to have adjustability relative to the frame, e.g., between an extended position and a retracted position. The method can further include adjusting the panel to increase or decrease clearance from other vehicle structures, e.g., wheels (e.g., with traction devices), fuel tanks, batteries, and/or other components and assemblies.

The panels, brackets, and other structures of the assemblies described herein can be formed of different materials. These materials can include without limitation metals, metal alloys, polymers, polymer composites, and/or natural materials, or any combination of the same.

The panels, brackets, and other structures of the assemblies described herein can be manufactured using different processes. These processes can include without limitation casting, e.g., metal casting or polymer casting, and/or machining, e.g., electrical-discharge machining (“EDM”), rolling, extruding, and/or stamping, among other methods.

The panels, brackets, and other structures of the assemblies described herein can be assembled using different methods, e.g., through attachment with fasteners, and/or through attachment with welding, bonding, and/or adhesives, and/or through other attachments methods that establish a desired relationship between components (e.g., substantially fixed in relation to each other or substantially movable in relation to each other).

The aspects and embodiments described herein can be manufactured, integrated, and/or utilized in connection with different types of vehicles. For example, while the figures herein depict embodiments in the context of one or more types of vehicles (e.g., freight trucks), the aspects and embodiments described herein can be used in connection with other sizes, classes, and types of vehicles (e.g., passenger vehicles, light-duty trucks, medium-duty trucks, heavy-duty trucks, buses, trams, carts, industrial vehicles, trains, aircraft, or other types of vehicles and equipment). Furthermore, the aspects and embodiments described herein can be used with internal combustion engine (“ICE”) vehicles, electric vehicles (“EV”), battery electric vehicles (“BEV”), hybrid electric vehicles (“HEV”), plug-in-hybrid electric vehicles (“PHEV”), and fuel-cell electric vehicles (“FCEV”), among others.

Clause 1. An adjustable fairing assembly for a vehicle comprising an aerodynamic panel; and a mounting bracket for attaching the aerodynamic panel to the vehicle, the mounting bracket comprising: a first member that attaches to the aerodynamic panel, a second member that attaches to the vehicle, and a movable coupling that allows the first member and the second member to shift between a retracted position and an extended position while the first member and the second member remain movably connected to each other.

Clause 2. The adjustable fairing assembly of clause 1, wherein the movable coupling comprises a first pin and a first slot, and wherein the first pin is slidably positioned in the first slot.

Clause 3. The adjustable fairing assembly of clause 1 or 2, wherein the first slot comprises a linear portion with a first stop-surface for the first pin and an arcuate portion with a second stop-surface for the first pin, and wherein the first stop-surface and the second stop-surface are located at opposite ends of the first slot.

Clause 4. The adjustable fairing assembly of any of clauses 1-3, wherein the first stop-surface and the second stop-surface each face in a first direction.

Clause 5. The adjustable fairing assembly of any of clauses 1-4, further comprising a biasing member coupled to the mounting bracket, wherein the biasing member biases the first member and the second member towards the retracted position.

Clause 6. The adjustable fairing assembly of any of clauses 1-5, wherein the biasing member is a spring.

Clause 7. The adjustable fairing assembly of any of clauses 1-6, wherein the movable coupling further comprises: a second slot, and a second pin, wherein the second pin is slidably positioned in the second slot.

Clause 8. The adjustable fairing assembly of any of clauses 1-7, wherein the movable coupling further comprises: a second slot, and a second pin, wherein the second pin is slidably positioned in the second slot.

Clause 9. The adjustable fairing assembly of any of clauses 1-8, wherein the first slot and the second slot are formed in the first member, and wherein the first pin and the second pin are coupled to the second member.

Clause 10. The adjustable fairing assembly of any of clauses 1-9, wherein the first slot and the second slot are formed in the second member, and wherein the first pin and the second pin are coupled to the first member.

Clause 11. An adjustable fairing assembly for a vehicle comprising: an aerodynamic panel; and a mounting bracket for attaching the aerodynamic panel to the vehicle, the mounting bracket comprising a movable coupling that allows the aerodynamic panel to slidably and rotatably shift between a retracted position and an extended position.

Clause 12. The adjustable fairing assembly of clause 11, wherein the movable coupling comprises a pin and a slot, wherein the slot comprises an arcuate shape, and wherein the pin is slidably positioned in the slot.

Clause 13. The adjustable fairing assembly of clause 11 or 12, wherein the slot comprises a first stop-surface for the pin and a second stop-surface for the pin, the first stop-surface and the second stop-surface located at opposite ends of the slot, and wherein the first stop-surface and the second stop-surface each face in a first direction.

Clause 14. The adjustable fairing assembly of any of clauses 11-13, further comprising a biasing member coupled to the mounting bracket, wherein the biasing member biases the pin against the first stop-surface in the retracted position and against the second stop-surface in the extended position.

Clause 15. The adjustable fairing assembly of any of clauses 11-14, wherein the mounting bracket comprises a first member that couples to the aerodynamic panel and a second member that couples to a chassis rail of the vehicle, and wherein the first member and the second member are connected by the movable coupling.

Clause 16. The adjustable fairing assembly of any of clauses 11-15, wherein the movable coupling comprises a pin and a slot, wherein the pin is coupled to the first member, and wherein the slot is formed in the second member.

Clause 17. The adjustable fairing assembly of any of clauses 11-16, wherein the movable coupling comprises a pin and a slot, wherein the pin is coupled to the second member, and wherein the slot is formed in the first member.

Clause 18. A vehicle comprising: a chassis; and an adjustable fairing assembly, comprising: an aerodynamic panel, and a mounting bracket that attaches the aerodynamic panel to part of the chassis, the mounting bracket comprising: a first member coupled to the aerodynamic panel, a second member coupled to the part of the chassis, and a movable coupling that allows the first member and the second member to shift between a retracted position and an extended position while the first member and the second member remain movably connected to each other.

Clause 19. The vehicle of clause 18, wherein the movable coupling comprises a pin and a slot, wherein the pin is slidably positioned in the slot, such that the pin can shift between a first stop-surface in the slot associated with the retracted position and a second stop-surface in the slot associated with the extended position.

Clause 20. The vehicle of clause 18 or 19, wherein the slot comprises a linear portion and a curved portion, wherein the curved portion is shaped such that it curves at least partially back towards the linear portion.

Clause 21. The vehicle of any of clauses 18-20, wherein the adjustable fairing assembly comprises one of a plurality of adjustable fairing assemblies attached along opposite lateral sides of the chassis.

Clause 22. The vehicle of any of clauses 18-21, wherein the adjustable fairing assembly comprises one of a plurality of adjustable fairing assemblies attached along opposite lateral sides of the chassis.

Clause 23. An adjustable fairing assembly for a vehicle comprising: an aerodynamic panel; and a mounting bracket for movably coupling the aerodynamic panel to a chassis rail of the vehicle, the mounting bracket comprising: a movable coupling that enables the aerodynamic panel to be slidingly and rotatably shifted between a retracted configuration and an extended configuration without disassembling and reassembling any portion of the adjustable fairing assembly.

Clause 24. The adjustable fairing assembly of clause 23, wherein the extended position is a position for which chains coupled to one or more tires proximal to the adjustable fairing assembly do not contact any portion of the adjustable fairing assembly while the tire(s) are stationary or rotating.

Clause 25. The adjustable fairing assembly of clause 23 or 24, wherein the mounting bracket further comprises a first member that couples to the aerodynamic panel; and a second member that couples to a chassis rail of the vehicle.

Clause 26. The adjustable fairing assembly of any of clauses 23-25, further comprising a biasing member which biases the adjustable fairing assembly towards the retracted position.

Clause 27. The adjustable fairing assembly of any of clauses 23-26, wherein the biasing member comprises a spring.

Clause 28. The adjustable fairing assembly of any of clauses 23-27, wherein the aerodynamic panel is substantially perpendicular to the chassis rail in both the retracted configuration and the extended configuration; and wherein the aerodynamic panel adopts an angled position with respect to the chassis rail during a movement configuration when going from the retracted position to the extended position, and vice versa.

Clause 29. A method of manufacturing and/or assembling an aerodynamic assembly according to any of clauses 1-28.

Clause 30. A method of integrating an aerodynamic assembly according to any of clauses 1-28 into a vehicle.

Clause 31. The preceding clauses 1-30 in any combination.

In some embodiments, this disclosure may include the language, for example, “at least one of [element A] and [element B].” This language may refer to one or more of the elements. For example, “at least one of A and B” may refer to “A,” “B,” or “A and B.” In other words, “at least one of A and B” may refer to “at least one of A and at least one of B,” or “at least either of A or B.” In some embodiments, this disclosure may include the language, for example, “[element A], [element B], and/or [element C].” This language may refer to either of the elements or any combination thereof. In other words, “A, B, and/or C” may refer to “A,” “B,” “C,” “A and B,” “A and C,” “B and C,” or “A, B, and C.” In addition, this disclosure may use the term “and/or” which may refer to any one or combination of the associated elements. In addition, this disclosure may use the term “a” (element) or “the” (element). This language may refer to the referenced element in the singular or in the plural and is not intended to be limiting in this respect.

The subject matter of this disclosure has been described in relation to particular embodiments, which are intended in all respects to be illustrative rather than restrictive. In this sense, alternative embodiments will become apparent to those of ordinary skill in the art to which the present subject matter pertains without departing from the scope hereof. In addition, different combinations and sub-combinations of elements disclosed, as well as use and inclusion of elements not shown, are possible and contemplated as well.

1. An adjustable fairing assembly for a vehicle, comprising: an aerodynamic panel; and a mounting bracket for attaching the aerodynamic panel to the vehicle, the mounting bracket comprising: a first member that attaches to the aerodynamic panel, a second member that attaches to the vehicle, and a movable coupling that allows the first member and the second member to shift between a retracted position and an extended position while the first member and the second member remain movably connected to each other.

2. The adjustable fairing assembly of claim 1, wherein the movable coupling comprises a first pin and a first slot, and wherein the first pin is slidably positioned in the first slot.

3. The adjustable fairing assembly of claim 2, wherein the first slot comprises a linear portion with a first stop-surface for the first pin and an arcuate portion with a second stop-surface for the first pin, and wherein the first stop-surface and the second stop-surface are located at opposite ends of the first slot.

4. The adjustable fairing assembly of claim 3, wherein the first stop-surface and the second stop-surface each face in a first direction.

5. The adjustable fairing assembly of claim 4, further comprising a biasing member coupled to the mounting bracket, wherein the biasing member biases the first member and the second member towards the retracted position.

6. The adjustable fairing assembly of claim 5, wherein the biasing member is a spring.

7. The adjustable fairing assembly of claim 6, wherein the movable coupling further comprises: a second slot, and a second pin, wherein the second pin is slidably positioned in the second slot.

8. The adjustable fairing assembly of claim 7, wherein the second slot comprises a linear shape without an arcuate portion.

9. The adjustable fairing assembly of claim 8, wherein the first slot and the second slot are formed in the first member, and wherein the first pin and the second pin are coupled to the second member.

10. The adjustable fairing assembly of claim 9, wherein the first slot and the second slot are formed in the second member, and wherein the first pin and the second pin are coupled to the first member.

11. An adjustable fairing assembly for a vehicle, comprising:
an aerodynamic panel; and a mounting bracket for attaching the aerodynamic panel to the vehicle, the mounting bracket comprising a movable coupling that allows the aerodynamic panel to slidably and rotatably shift between a retracted position and an extended position.

12. The adjustable fairing assembly of claim 11, wherein the movable coupling comprises a pin and a slot, wherein the slot comprises an arcuate shape, and wherein the pin is slidably positioned in the slot.

13. The adjustable fairing assembly of claim 12, wherein the slot comprises a first stop-surface for the pin and a second stop-surface for the pin, the first stop-surface and the second stop-surface located at opposite ends of the slot, and wherein the first stop-surface and the second stop-surface each face in a first direction.

14. The adjustable fairing assembly of claim 13, further comprising a biasing member coupled to the mounting bracket, wherein the biasing member biases the pin against the first stop-surface in the retracted position and against the second stop-surface in the extended position.

15. The adjustable fairing assembly of claim 11, wherein the mounting bracket comprises a first member that couples to the aerodynamic panel and a second member that couples to a chassis rail of the vehicle, and wherein the first member and the second member are connected by the movable coupling.

16. The adjustable fairing assembly of claim 15, wherein the movable coupling comprises a pin and a slot, wherein the pin is coupled to the first member, and wherein the slot is formed in the second member.

17. The adjustable fairing assembly of claim 15, wherein the movable coupling comprises a pin and a slot, wherein the pin is coupled to the second member, and wherein the slot is formed in the first member.

18. A vehicle, comprising: a chassis; and an adjustable fairing assembly, comprising: an aerodynamic panel, and a mounting bracket that attaches the aerodynamic panel to part of the chassis, the mounting bracket comprising: a first member coupled to the aerodynamic panel, a second member coupled to the part of the chassis, and a movable coupling that allows the first member and the second member to shift between a retracted position and an extended position while the first member and the second member remain movably connected to each other.

19. The vehicle of claim 18, wherein the movable coupling comprises a pin and a slot, wherein the pin is slidably positioned in the slot, such that the pin can shift between a first stop-surface in the slot associated with the retracted position and a second stop-surface in the slot associated with the extended position.

20. The vehicle of claim 19, wherein the slot comprises a linear portion and a curved portion, wherein the curved portion is shaped such that it curves at least partially back towards the linear portion.

21. (canceled)

22. (canceled)
